(19) United States
(12) Patent Application Publication
(10) Pub. No.: US 2025/0094074 A1
(43) Pub. Date: Mar. 20, 2025

(54) ELECTRONIC DEVICE FOR MANAGING DATA AND DATA MANAGEMENT METHOD

(71) Applicant: Samsung Electronics Co., Ltd., Suwon-si (KR)

(72) Inventors: Hyejung KIM, Suwon-si (KR); Junho KIM, Suwon-si (KR)

(21) Appl. No.: 18/966,873

(22) Filed: Dec. 3, 2024

Related U.S. Application Data
(63) Continuation of application No. PCT/KR2023/007210, filed on May 25, 2023.

(30) Foreign Application Priority Data
Jul. 27, 2022 (KR) 10-2022-0093295
Aug. 4, 2022 (KR) 10-2022-0097309

(51) Int. Cl. G06F 3/06

(52) U.S. Cl. CPC G06F 3/0652; G06F 3/0622; G06F 3/0673

(57) ABSTRACT

An electronic device is provided. The electronic device includes memory storing one or more computer programs, a display, and one or more processors, wherein the one or more computer programs include computer-executable instructions that, when executed by the one or more processors individually or collectively, cause the electronic device to: display, on the display, an execution screen of an application including state information about deletion target data of a plurality of applications installed on the electronic device, the execution screen including a first object requesting the deletion target data, transmit a command to each of the plurality of applications to delete the deletion target data of the plurality of applications based on a user input to the first object, when first deletion target data of a first application among the plurality of applications is stored in a first area accessible by the first application, display information about a deletion result of deletion of the first deletion target data, and when second deletion target data of a second application among the plurality of applications is stored in a second area requiring an access authority, display information requesting a deletion authority of the second deletion target data.

### CROSS-REFERENCE TO RELATED APPLICATION(S)

This application is a continuation application, claiming priority under § 365(c), of an International application No. PCT/KR2023/007210, filed on May 25, 2023, which is based on and claims the benefit of a Korean patent application number 10-2022-0093295, filed on Jul. 27, 2022, in the Korean Intellectual Property Office, and of a Korean patent application number 10-2022-0097309, filed on Aug. 4, 2022, in the Korean Intellectual Property Office, the disclosure of each of which is incorporated by reference herein in its entirety.

### BACKGROUND

### 1. Field

The disclosure relates to an electronic device for managing data and a data management method.

### 2. Description of Related Art

To provide various services through an electronic device, at least one application may be installed on the electronic device. For example, an electronic device may have, installed thereon, a music application for playing the user's desired sound source, a call application for a voice call service, a message application for sending a message, and/or a camera application for a camera service. At least one application may support a recycle bin function. The recycle bin function may refer to a function of storing or retaining the data requested to be deleted by the user for a certain period of time.

The recycle bin function may store or retain the data requested to be deleted by the user in an individual space accessible only by a corresponding application or a shared space accessible by all the applications obtaining access authority.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for managing data and a data management method.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, a display, and one or more processors, wherein the one or more computer programs include computer-executable instructions that, when executed by the one or more processors individually or collectively, cause the electronic device to display, on the display, an execution screen of an application including state information about deletion target data of a plurality of applications installed on the electronic device, the execution screen including a first object requesting to delete the deletion target data, transmit a command to each of the plurality of applications to delete the deletion target data of the plurality of applications based on a user input to the first object, when first deletion target data of a first application among the plurality of applications is stored in a first area accessible by the first application, display information about a deletion result of the first deletion target data, and when second deletion target data of a second application among the plurality of applications is stored in a second area requiring an access authority, display information requesting a deletion authority of the second deletion target data.

In accordance with another aspect of the present disclosure, a method for operating an electronic device is provided. The method includes displaying, on a display included in the electronic device, an execution screen of an application including state information about deletion target data of a plurality of applications installed on the electronic device, the execution including a first object requesting to delete the deletion target data, transmitting a command to each of the plurality of applications to delete the deletion target data of the plurality of applications based on a first user input to the first object, when first deletion target data of a first application among the plurality of applications is stored in a first area accessible by the first application, displaying information about a deletion result of the first deletion target data, and when second deletion target data of a second application among the plurality of applications is stored in a second area requiring an access authority, displaying information requesting a deletion authority of the second deletion target data.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include displaying, on a display included in an electronic device, an execution screen of an application including state information about deletion target data of a plurality of applications installed on the electronic device, the execution screen including a first object requesting to delete the deletion target data, transmitting a command to each of the plurality of applications to delete the deletion target data of the plurality of applications based on a first user input to the first object, when first deletion target data of a first application among the plurality of applications is stored in a first area accessible by the first application, displaying information about a deletion result of the first deletion target data, and when second deletion target data of a second application among the plurality of applications is stored in a second area requiring an access authority, displaying information requesting a deletion authority of the second deletion target data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a view illustrating memory of an electronic device according to an embodiment of the disclosure;

FIG. 3 is a view illustrating operations of a plurality of applications installed on an electronic device according to an embodiment of the disclosure;

FIG. 4 is a flowchart illustrating an operation method of an electronic device according to an embodiment of the disclosure;

FIG. 5 is a flowchart illustrating an operation method of an electronic device according to an embodiment of the disclosure;

FIG. 6 is a view illustrating displaying a popup window as to whether to grant an access authority on a display according to an embodiment of the disclosure;

FIG. 7 is a flowchart illustrating an operation method of an electronic device according to an embodiment of the disclosure;

FIGS. 8A, 8B, and 8C are views illustrating an execution screen of an application according to various embodiments of the disclosure;

FIG. 9 is a view illustrating an execution screen of an application according to an embodiment of the disclosure;

FIG. 10 is a view illustrating displaying a shortcut icon to be visually distinct depending on the degree of deletion of deletion target data according to an embodiment of the disclosure;

FIGS. 11A and 11B are views illustrating an execution screen of an application displayed when a shortcut icon is selected according to various embodiments of the disclosure;

FIG. 12 is a view illustrating a widget displayed on a home screen of an electronic device according to an embodiment of the disclosure; and

FIG. 13 is a view illustrating information about an application and a recycle bin path of the corresponding application according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

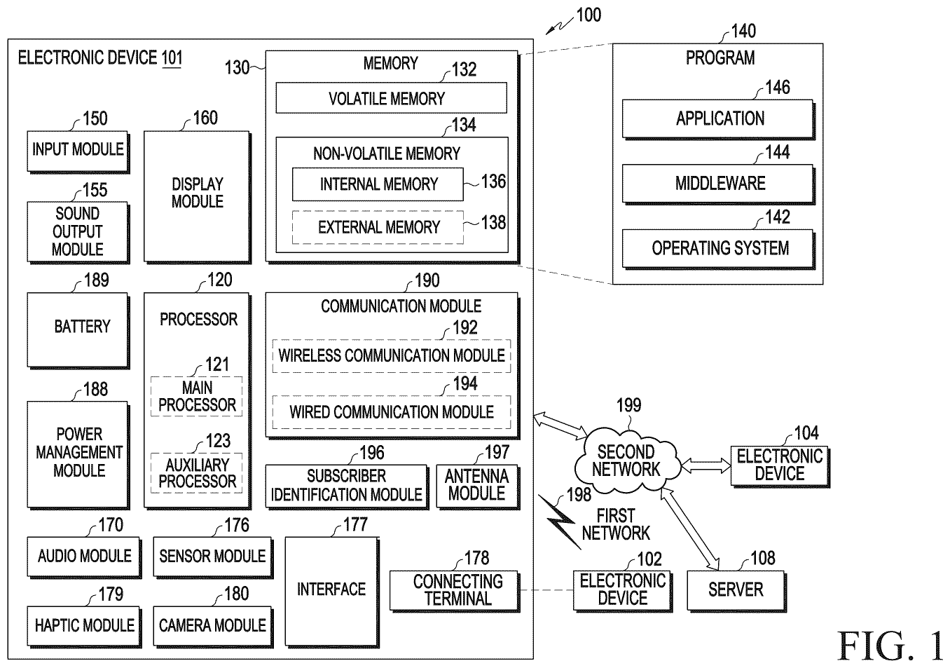

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

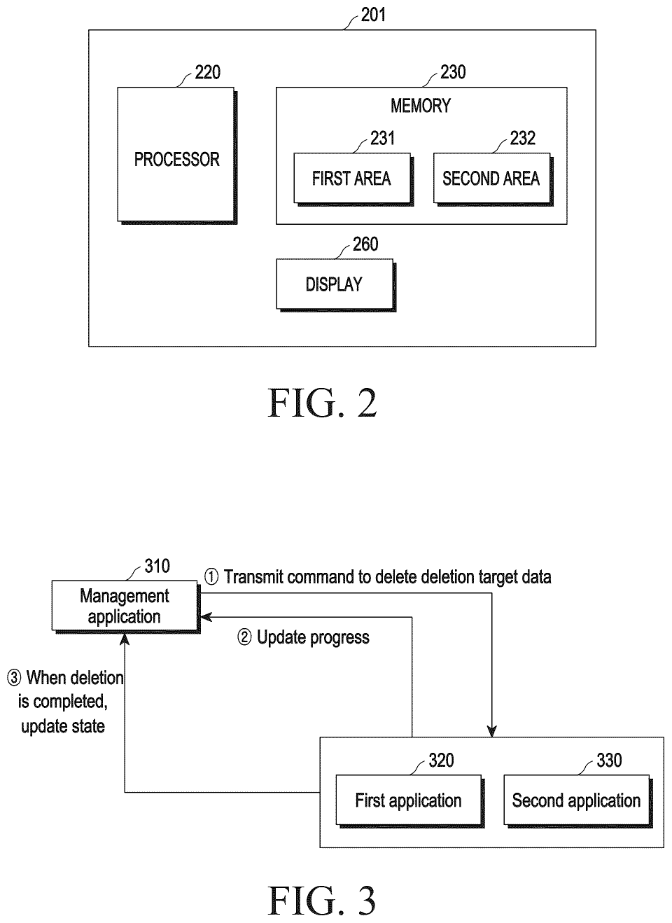

FIG. 2 is a view illustrating memory of an electronic device according to an embodiment of the disclosure.

According to an embodiment, an electronic device 201 may include a processor 220, memory 230, and a display 260. For example, the electronic device 201 may be implemented to be identical or similar to the electronic device 101 of FIG. 1.

According to an embodiment, the processor 220 may control the overall operation of the electronic device 201. For example, the processor 220 may be implemented to be identical or similar to the processor 120 of FIG. 1.

According to an embodiment, the processor 220 may execute a management application for managing a trash may function.

According to an embodiment, the processor 220 may display the execution screen of the management application (e.g., the management application 310 of FIG. 3) for managing the recycle bin function on the display 260. For example, the execution screen of the management application may include information about deletion target data (e.g., state information about deletion target data) of a plurality of applications installed on the electronic device 201. For example, the execution screen of the management application 310 may include an object for requesting deletion (or batch deletion) of the deletion target data installed on the electronic device 201. For example, the deletion target data may refer to data requested to be deleted by the user, which is not permanently deleted, among data for the corresponding application. For example, the application supporting the recycle bin function may store or retain the deletion target data requested to be deleted by the user in the memory 230 for a predetermined period of time.

According to an embodiment, the processor 220 may transmit a command (e.g., a delete command) to each of the plurality of applications to permanently delete deletion target data of the plurality of applications, based on a user input (e.g., a touch input) to the first object.

According to an embodiment, when first deletion target data of the first application (e.g., 320 of FIG. 3) among the plurality of applications installed on the electronic device 201 is stored in a first area 231 accessible only by the first application 320, the first deletion target data of the first application 320 may be deleted based on the command. The processor 220 may display information about the deletion result of the first deletion target data on the execution screen of the management application.

According to an embodiment, when the second deletion target data of a second application (e.g., 330 of FIG. 3) among the plurality of applications installed on the electronic device 201 is stored in a second area 232 requiring the access authority, the second deletion target data of the second application may not be deleted based on the command. The processor 220 may display information for requesting the authority to delete the second deletion target data on the execution screen of the management application 310.

According to an embodiment, the memory 230 may be implemented as identical or similar to the memory 130 of FIG. 1. For example, the memory 230 may store the plurality of applications installed on the electronic device 201. Further, the memory 230 may store the management application for managing the function.

According to an embodiment, the memory 230 may include the first area 231 and the second area 232. According to an embodiment, the first area 231 and the second area 232 may include logically distinct areas. According to an embodiment, the first area 231 and the second area 232 may store deletion target data related to the application supporting the recycle bin function. For example, each of the plurality of applications supporting the recycle bin function installed on the electronic device 201 may store or retain the deletion target data in the first area 231 or the second area 232. For example, the first application (e.g., 320 of FIG. 3) among the plurality of applications installed on the electronic device 201 may store the deletion target data of the first application in the first area 231. Further, the second application (e.g., 330 of FIG. 3) among the plurality of applications installed on the electronic device 201 may store the deletion target data of the second application in the second area 232. The recycle bin function may include a function of storing the deleted data in the memory 230 for a preset period of time when the application deletes the data. According to an embodiment, the first area 231 and the second area 232 may store the deletion target data for a preset period of time to determine whether to permanently delete or restore the deletion target data. According to an embodiment, the deletion target data may include an image file, a text file, an audio file, a video file, and/or clipboard data deleted in a state in which the application is executed. However, this is merely an example, and embodiments of the disclosure may not be limited thereto.

According to an embodiment, the first area 231 may include a specific application-only (private) area accessible only by a specific application. The first area 231 may include an area separately allocated or designated for each of the applications. For example, the first area 231 may include a dedicated area of a Gallery application, a dedicated area of a memo application, or a dedicated area of a message application. Only the Gallery application may access the dedicated area of the Gallery application, only the memo application may access the dedicated area of the memo application, and only the memory application may access the dedicated area of the message application. For example, the Gallery application may store the deletion target data in the dedicated area of the Gallery application, the memo application may store the deletion target data in the dedicated area of the memo application, and the message application may store the deletion target data in the dedicated area of the message application. According to an embodiment, the second area 232 may include a shared area accessible by application that have obtained an access authority among the plurality of applications installed on the electronic device 201. For example, the second area 232 may refer to an area in which applications that have obtained access authority share and store or retain the deletion target data. For example, each of the music playback application and the schedule management application may store corresponding deletion target data in the second area 232.

According to an embodiment, the first application supporting the first area 231 as the recycle bin area may access the first area 231 to delete the deletion target data stored in the first area 231. According to an embodiment, the second application supporting the second area 232 as the recycle bin area may obtain access authority to access the second area 232 and delete the deletion target data stored in the second area 232. According to an embodiment, the access authority may be obtained in advance by a user input before deleting the deletion target data stored in the second area 232, or may be obtained when deleting the deletion target data stored in the second area 232.

According to an embodiment, the display 260 may display the execution screen of the management application for managing the recycle bin function under the control of the processor 220. Further, the display 260 may display a shortcut icon supported by the management application on the home screen under the control of the processor 220.

Operations of the electronic device described below may be performed by the processor 220. However, for convenience of description, it is described that the operations performed by the processor 220 are performed by the electronic device 201.

FIG. 3 is a view illustrating operations of a plurality of applications installed on an electronic device according to an embodiment of the disclosure.

According to an embodiment, the electronic device 201 may execute the management application 310 for managing the deletion target data of the plurality of applications 320 and 330 supporting the recycle bin function. According to an embodiment, the management application 310 may provide a user interface for deleting the deletion target data stored in the first area 231 and/or the second area 232.

According to an embodiment, the electronic device 201 may control the management application 310 to transmit, to the plurality of applications 320 and 330, a command for allowing each of the plurality of applications 320 and 330 to delete the deletion target data stored in the memory 230. Accordingly, the electronic device 201 may transmit the command for deleting the deletion target data of the plurality of applications 320 and 330 through the management application 310 without the need for deleting the deletion target data by directly accessing the first area 231 and/or the second area 232 in state in which the plurality of applications 320 and 330 are executed.

According to an embodiment, the plurality of applications 320 and 330 may access the first area 231 or the second area 232 of the memory 230 to delete the deletion target data based on the command.

According to an embodiment, the plurality of applications 320 and 330 may transmit the deletion progress of the deletion target data to the management application 310 in real time or according to a preset period.

According to an embodiment, the management application 310 may update the deletion progress (e.g., deletion completion or deletion failure) of the deletion target data and may display the same on the execution screen of the management application 310. Alternatively, the management application 310 may display the deletion progress (e.g., deletion completion or deletion failure) of the deletion target data through a popup window.

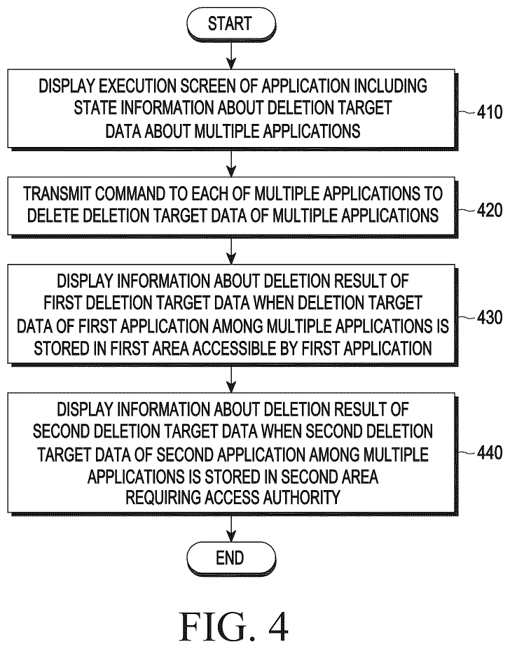

FIG. 4 is a flowchart illustrating an operation method of an electronic device according to an embodiment of the disclosure.

According to an embodiment, in operation 410, the electronic device 201 may display the execution screen of the management application 310 for managing the recycle bin function on the display 260. The execution screen of the management application 310 may include state information about the deletion target data of the plurality of applications supporting the recycle bin function installed on the electronic device (e.g., the electronic device 201 of FIG. 2). According to an embodiment, the execution screen may include an object requesting batch deletion of deletion target data. According to an embodiment, the electronic device 201 may identify a user input for selecting an object for requesting batch deletion of the deletion target data of the plurality of applications supporting the recycle bin function.

According to an embodiment, in operation 420, the electronic device 201 may transmit a command (e.g., a command for requesting to delete the deletion target data) to each of the plurality of applications to delete (or batch-delete) the deletion target data of the plurality of applications supporting the recycle bin function based on a user input for selecting the object requesting batch deletion of the deletion target data.

According to an embodiment, when the first deletion target data of the first application 320 among the plurality of applications is stored in the first area 231 accessible by the first application 320, the electronic device 201 may display information about the deletion result of the first deletion target data in operation 430. According to an embodiment, when the first deletion target data of the first application 320 is stored in the first area 231, the first application 320 may delete the first deletion target data stored in the first area 231 in response to the command. According to an embodiment, the first application 320 may transmit, to the management application 310, information about the deletion result indicating that the first deletion target data has been deleted. According to an embodiment, the management application 310 may update and display information (e.g., information about the deletion result) indicating that the first deletion target data has been deleted on the execution screen of the management application 310.

According to an embodiment, when the second deletion target data of the second application 330 among the plurality of applications is stored in the second area 232 requiring access authority, the electronic device 201 may display information about the deletion result of the second deletion target data in operation 440. According to an embodiment, the electronic device 201 may display information for requesting the authority to delete the second deletion target data on the execution screen of the management application 310. According to an embodiment, when the second application 330 has the authority to access the second area 232, the second application 330 may delete the second deletion target data without displaying information for requesting the authority to delete the second deletion target data, in response to the command.

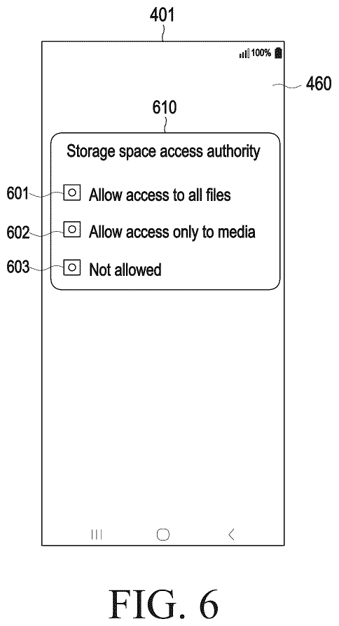

According to an embodiment, when the second application 330 does not have the authority to access the second area 232, the second application 330 may not delete the second deletion target data in response to the command. Further, the second application 330 may request the authority to delete the second deletion target data. For example, the second application 330 may display a user interface (e.g., a popup window) (e.g., 610 of FIG. 6) for requesting the authority to delete the second deletion target data. The second application 330 may obtain a user input regarding the authority to delete the second deletion target data through the user interface. The second application 330 may delete the second deletion target data after obtaining the deletion authority according to the user input. For example, the second application 330 may delete the second deletion target data in response to the command received after obtaining the deletion authority according to the user input.

According to an embodiment, although it is illustrated that operation 440 is performed after operation 430, operation 440 may be performed before operation 430, or operation 430 and operation 440 may be performed simultaneously.

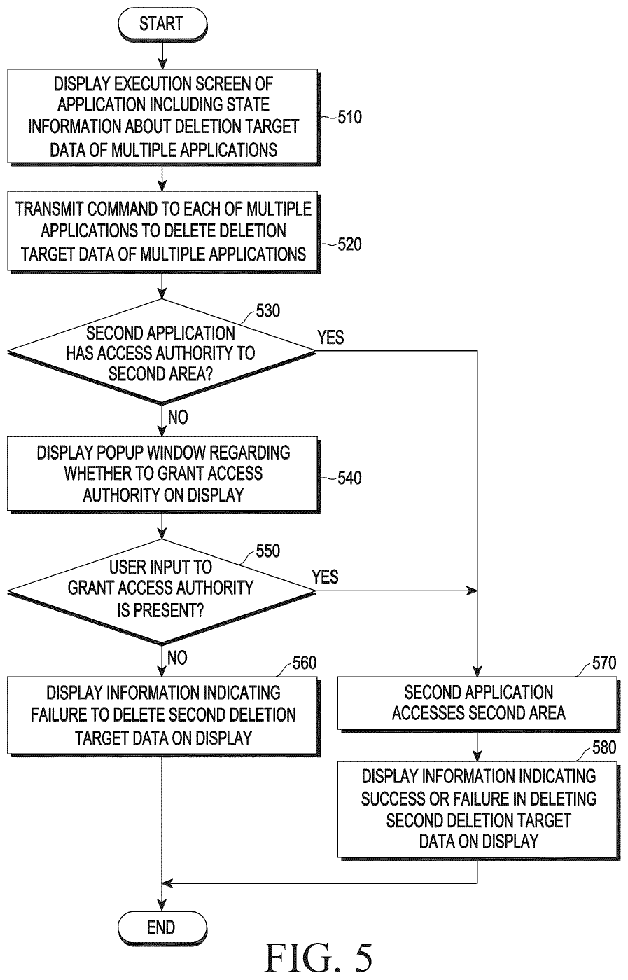

FIG. 5 is a flowchart illustrating an operation method of an electronic device according to an embodiment of the disclosure.

According to an embodiment, in operation 510, the electronic device 201 may display the execution screen of the management application 310 including state information about the deletion target data of the plurality of applications. According to an embodiment, the state information about the deletion target data may include capacity information about the deletion target data of each of the plurality of applications and/or the number of files.

According to an embodiment, in operation 520, the electronic device 201 may transmit a command to each of the plurality of applications to delete the deletion target data of the plurality of applications.

According to an embodiment, the electronic device 201 may identify whether the second application 330 has obtained the access authority to the second area 232 in operation 530. According to an embodiment, the electronic device 201 may be preset by the user to obtain an access authority for allowing the second application 330 to access the second area 232.

According to an embodiment, when it is identified that the second application 330 has not obtained the access authority to the second area 232, the electronic device 201 may display a popup window (e.g., 610 of FIG. 6) including a message regarding whether to grant the access authority on the display (the display 260 of FIG. 2) in operation 540.

According to an embodiment, in operation 550, the electronic device 201 may identify a user input for granting an access authority to the second area 232. For example, the access authority may refer to the authority by which the second application 330 may access all kinds of deletion target data of the second application 330 stored in the second area 232 to delete all kinds of deletion target data. Alternatively, the access authority may refer to the authority by which the second application 330 is allowed to access only at least one kind (e.g., media file) of deletion target data among all kinds of deletion target data stored in the second area 232 to delete only the at least one kind (e.g., media file) of deletion target data. However, this is merely an example, and embodiments of the disclosure may not be limited thereto.

According to an embodiment, when the user input for granting the access authority to the second area 232 is not identified, the electronic device 201 may display, on the display 260, information indicating that deletion of the second deletion target data has failed in operation 560. According to an embodiment, the electronic device 201 may control the second application 330 to transmit information indicating that the second deletion target data has not been deleted to the management application 310. According to an embodiment, the electronic device 201 may display the information indicating that the second deletion target data has not been deleted on the execution screen of the management application 310.

According to an embodiment, when it is identified that the second application 330 has the access authority to the second area 232 (Yes in operation 530) or a user input for granting the access authority to the second area 232 is identified (Yes in operation 550), in operation 570, the electronic device 201 may control the second application 330 to access the second area 232.

According to an embodiment, in operation 580, the electronic device 201 may display, on the display 260, information indicating that deletion of the second deletion target data succeeds or fails. According to an embodiment, the second application 330 may succeed in accessing the second area 232, but may fail to delete the second deletion target data for reasons other than the access authority. According to an embodiment, the electronic device 201 may control the second application 330 to transmit the information indicating that the deletion of the second deletion target data succeeds or fails to the management application 310. According to an embodiment, the electronic device 201 may display the information indicating that the deletion of the second deletion target data succeeds or fails on the execution screen of the management application 310.

FIG. 6 is a view illustrating displaying a popup window as to whether to grant an access authority on a display according to an embodiment of the disclosure.

According to an embodiment, when it is identified that the second application 330 has not obtained the access authority to the second area 232, the electronic device 401 (e.g., the electronic device 201 of FIG. 2) may display a popup window 610 including a message regarding whether to grant the access authority on the display 460 (e.g., the display 260 of FIG. 2).

According to an embodiment, the popup window 610 may include a plurality of objects 601, 602, and 603. According to an embodiment, the first object 601 may include an object for making a configuration to allow the second application 330 to all kinds of deletion target data of the second application 330 stored in the second area 232 or delete all kinds of deletion target data.

According to an embodiment, the second object 602 may include an object for making a configuration to allow the second application 330 to access or delete one kind of data (e.g., a media file) of the second application 330 among the deletion target data stored in the second area 232.

According to an embodiment, the third object 603 may include an object for making a configuration not to allow the second application 330 to access the second area 232 or delete the deletion target data stored in the second area 232.

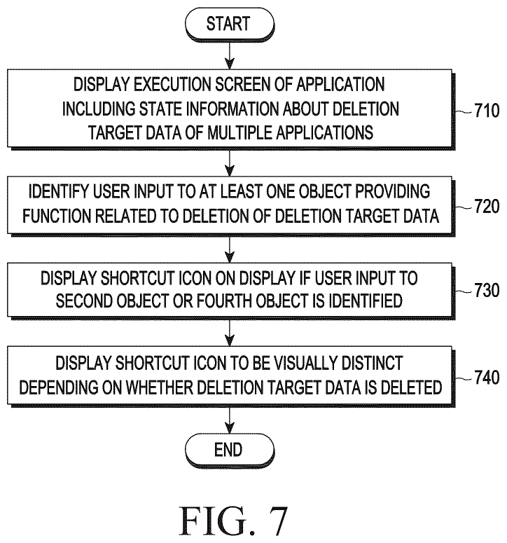

FIG. 7 is a flowchart illustrating an operation method of an electronic device according to an embodiment of the disclosure.

According to an embodiment, in operation 710, the electronic device 201 or 401 may display the execution screen of the management application 310 including state information about deletion target data of the plurality of applications.

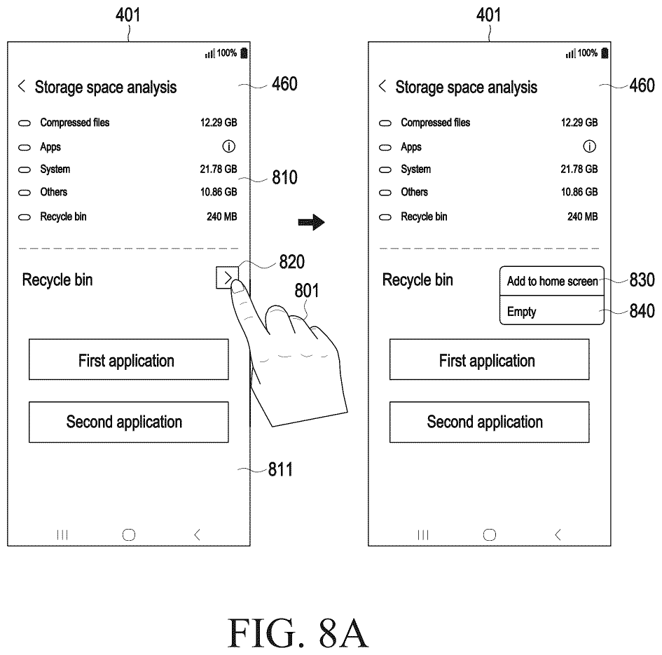

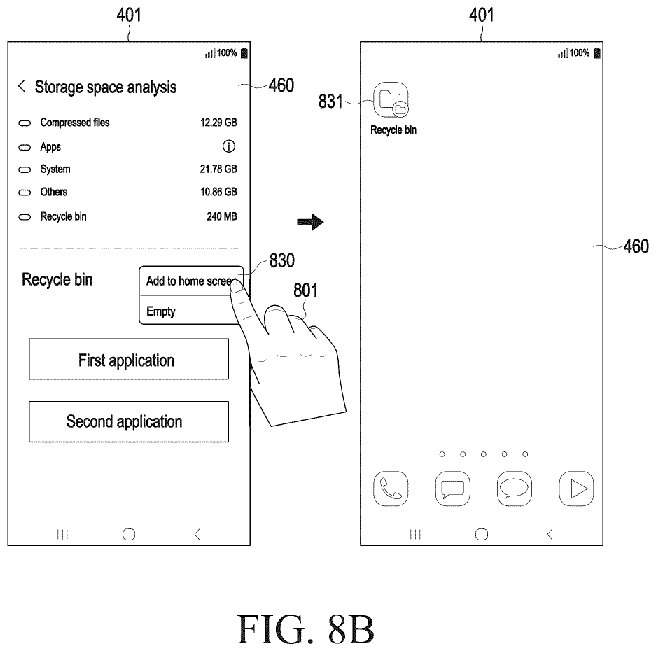

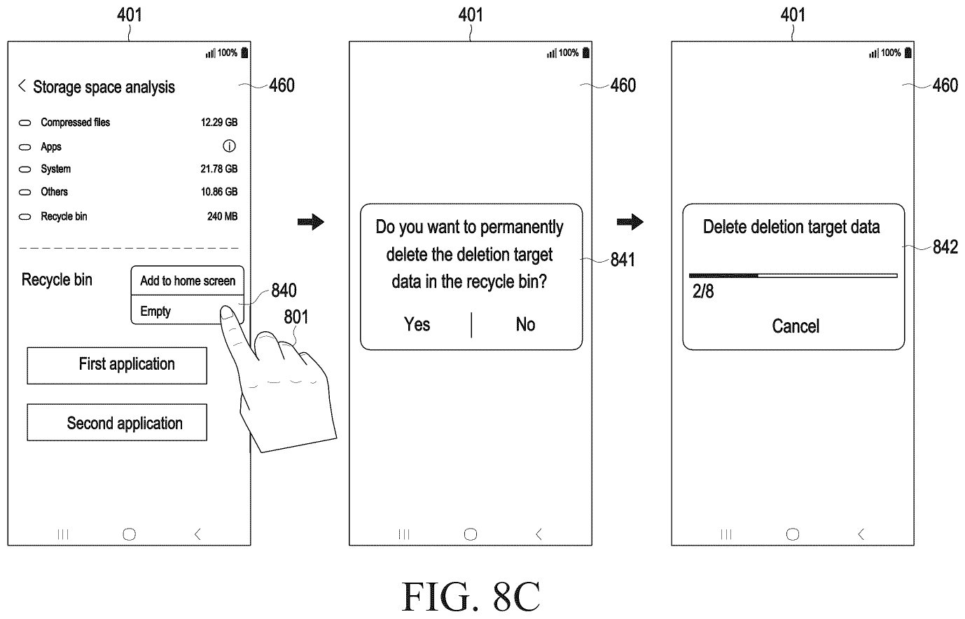

According to an embodiment, the electronic device 201 or 401 may include at least one object that provides a function related to deletion of deletion target data included in the execution screen of the management application 310. According to an embodiment, in operation 720, the electronic device 201 or 401 may identify a user input to at least one object providing the function related to deletion of the deletion target data. According to an embodiment, the execution screen of the management application 310 may include a first object (e.g., 840 of FIG. 8A) for batch-deleting deletion target data stored in the first area 231 and the second area 232 and/or a second object (e.g., 830 of FIG. 8A) for adding a shortcut icon for the first object to the home screen. Alternatively, according to an embodiment, the execution screen of the management application 310 may include a third object (not shown) for individually deleting deletion target data stored in the first area 231 or the second area 232 and/or a fourth object (not shown) for adding a shortcut icon for the third object to the home screen.

According to an embodiment, when a user input to the second object or the fourth object is identified in operation 730, the electronic device 201 or 401 may display the shortcut icon on the display 260 or 460. According to an embodiment, when a user input to the second object or the fourth object is identified, the electronic device 201 or 401 may display the shortcut icon on the home screen.

According to an embodiment, in operation 740, the electronic device 201 or 401 may display, on the display 260 or 460, the shortcut icon to be visually distinct according to whether the deletion target data is deleted. According to an embodiment, the electronic device 201 or 401 may adjust the brightness, shading, color, and/or transparency of the shortcut icon according to the degree of deletion of the deletion target data. For example, the electronic device 201 or 401 may apply a dim effect to the shortcut icon according to the degree of deletion of the deletion target data. For example, when the deletion target data of a specific application occupies 50% of the total capacity of the first area 231 or the second area 232, the electronic device 201 or 401 may adjust the shading of the shortcut icon to 50% of the total. Further, when the deletion target data occupies 70% of the total capacity of the first area 231 or the second area 232, the electronic device 201 or 401 may adjust the shading of the shortcut icon to 70% of the total. In this case, the shading of 70% may be darker than the shading of 50%. When the electronic device 201 or 401 deletes all the deletion target data of the specific application stored in the first area 231 or the second area 232, the electronic device 201 or 401 may deactivate the shortcut icon. For example, the electronic device 201 or 401 may ignore a user input to the deactivated icon. Alternatively, the electronic device 201 or 401 may transparently display the deactivated icon.

FIGS. 8A, 8B, and 8C are views illustrating an execution screen of an application according to various embodiments of the disclosure.

FIG. 8A is a view illustrating an execution screen of an application (e.g., the management application 310 of FIG. 3) including state information about deletion target data of a plurality of applications installed on the electronic device 401.

According to an embodiment, if the management application 310 is executed, the electronic device 401 (e.g., the electronic device 201 of FIG. 2) may display a storage space analysis screen for managing the deletion target data of a plurality of applications (e.g., the first application (e.g., 320 of FIG. 3) and the second application (e.g., 330 of FIG. 3) on the display 460 (e.g., 260 of FIG. 2).

According to an embodiment, the storage space analysis screen may include a first screen 810 indicating capacity information occupied by deletion target data in memory (e.g., the memory 230 of FIG. 2) and a recycle bin management screen 811 capable of managing the deletion target data of the plurality of applications supporting the recycle bin function. According to an embodiment, FIG. 8A illustrates only an object related to the first application 320 and an object related to the second application 330 on the recycle bin management screen 811, but the recycle bin management screen 811 may further display information about the capacity of the deletion target data of the first application 320 and/or the second application 330, the number of deletion target data, the available capacity of the first area 231, and/or the available capacity of the second area 232.

According to an embodiment, if a user input to the object 820 displayed on the recycle bin management screen 811 is identified, the electronic device 401 may display a first object 840 for deleting (e.g., batch-deleting) deletion target data stored in the first area 231 and the second area 232 and/or a second object 830 for adding a shortcut icon to the home screen.

Referring to FIG. 8B, according to an embodiment, if a user input 801 to the second object 830 for adding a shortcut icon to the home screen is identified, the electronic device 401 may display a shortcut icon 831 for the first object 840 on the home screen.

Referring to FIG. 8C, according to an embodiment, when the user selects the first object 840 for deleting (e.g., batch-deleting) the deletion target data stored in the first area 231 and the second area 232, the electronic device 401 may display the deletion progress of the deletion target data on the display 460.

According to an embodiment, if the user input 801 to the first object 840 for deleting (e.g., batch-deleting) the deletion target data stored in the first area 231 and the second area 232 is identified, the electronic device 401 may display a popup window 841 including a message confirming deletion (e.g., “Do you want to permanently delete the deletion target data in the recycle bin?”).

According to an embodiment, if a user input to “No” is identified, the electronic device 401 may not transmit a command for deleting deletion target data to the first application 320 and the second application 330.

According to an embodiment, if a user input to “Yes” is identified, the electronic device 401 may transmit a command for deleting the deletion target data to each of the first application 320 and the second application 330.

According to an embodiment, the electronic device 401 may display, on the display 460, a screen 842 indicating the progress in which the first application 320 and the second application 330 access the first area 231 and/or the second area 232 to delete deletion target data. According to an embodiment, the first application 320 and the second application 330 may transmit information indicating the deletion progress of the deletion target data to the management application 310. The management application 310 may update the deletion progress based on the information indicating the deletion progress, and display the updated deletion progress information on the execution screen. For example, the screen 842 indicating the progress of deleting the deletion target data may include “the number of applications that have deleted the deletion target data/the number of applications to delete the deletion target data”, “the number of deleted files/the number of files to be deleted”, or “the number of deleted files for each application/the number of files to be deleted for each application”. However, this is merely an example, and embodiments of the disclosure may not be limited thereto.

According to an embodiment, the electronic device 401 may display a popup window for identifying whether to grant authority to delete the second deletion target data stored in the second area 232 to the second application 330 after the first application 320 completes deletion of the first deletion target data or while the first deletion target data is being deleted. Although the popup window is not illustrated in FIG. 8C, the popup window may be implemented in the same or similar manner as the popup window illustrated in FIG. 6.

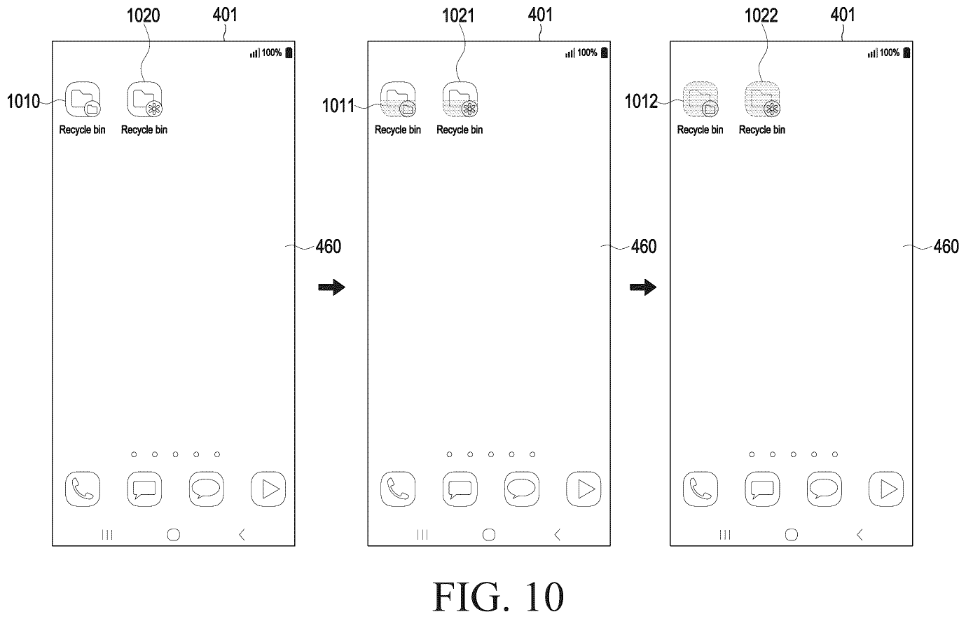

According to an embodiment, when the electronic device 401 completes the deletion of the deletion target data stored in the first area 231 and the second area 232, the generated shortcut icon 831 may be automatically deleted from the home screen. According to an embodiment, when the electronic device 401 completes deletion of all the deletion target data of the first application 320 or the second application 330 (e.g., Gallery application) stored in the first area 231 and the second area 232, the generated shortcut icon (e.g., 1020 of FIG. 10) may be automatically deleted from the home screen.

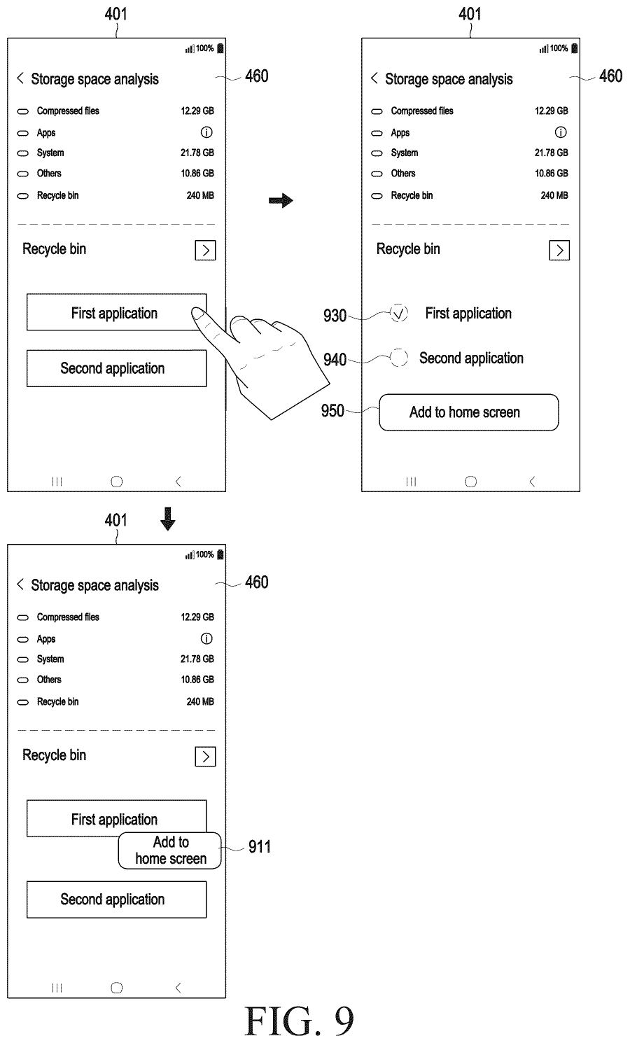

FIG. 9 is a view illustrating an execution screen of an application according to an embodiment of the disclosure.

According to an embodiment, the electronic device 401 (e.g., the electronic device 101 of FIG. 1 or the electronic device 201 of FIG. 2) may add a shortcut icon for requesting deletion of deletion target data for each application to the home screen.

According to an embodiment, if a user input to a first application (e.g., the first application 320 of FIG. 3) or a second application (e.g., the second application 330 of FIG. 3) is identified, the electronic device 401 may display, on the display 460, an object 930 or 940 for selecting the first application 320 and/or the second application 330 to add the shortcut icon to the home screen. For example, the user input may include a user input of long pressing the first application 320 or the second application 330. However, this is merely an example, and the method of selecting the corresponding application may not be limited thereto.

According to an embodiment, the electronic device 401 may display, on the display 460, objects 930 and 940 indicating the plurality of applications and an object 950 capable of adding a shortcut icon of the selected application to the home screen, based on the identification of the long press input.

According to an embodiment, if a user input to the first application 320 is identified, the electronic device 401 may display an object 911 capable of adding a shortcut icon of the first application 320 to the home screen. For example, the user input may include a user input of tapping or touching the first application 320 or the second application 330. However, this is merely an example, and the method of selecting the corresponding application may not be limited thereto.

According to an embodiment, if a user input (e.g., a long press) to the shortcut icon added to the home screen is identified, the electronic device 401 may delete the corresponding shortcut icon.

FIG. 10 is a view illustrating displaying a shortcut icon to be visually distinct depending on the degree of deletion of deletion target data according to an embodiment of the disclosure.

According to an embodiment, the electronic device 401 may apply a dim effect to the shortcut icon added to the home screen according to the degree of deletion of the deletion target data, and may display the same on the display 460.

According to an embodiment, when the available capacity of the first area 231 and/or the second area 232 is 100% (e.g., a state in which the first area 231 or the second area 232 is fully emptied), the electronic device 401 may display the shortcut icons 1010 and 1020 without shading.

According to an embodiment, when the available capacity of the first area 231 and/or the second area 232 is 50%, the electronic device 401 may display dim effect-applied shortcut icons 1011 and 1021, corresponding to the available capacity. According to an embodiment, when the available capacity of the first area 231 and/or the second area 232 is 50%, the electronic device 401 may adjust and display the shading of the shortcut icons 1011 and 1021 to 50% of the total.

According to an embodiment, when the available capacity of the first area (e.g., 231 of FIG. 2) and/or the second area (e.g., 232 of FIG. 2) is 0% (e.g., a state in which the first area 231 or the second area 232 is fully filled), the electronic device 401 may adjust and display the shading of the shortcut icons 1012 and 1022 to 100% of the total.

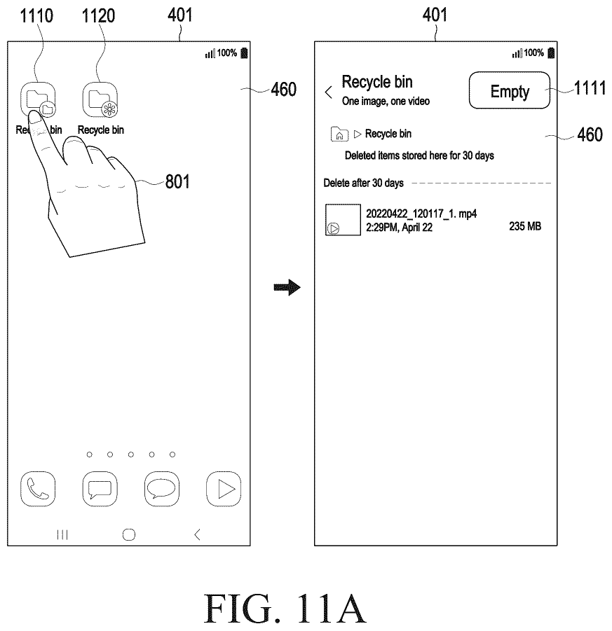

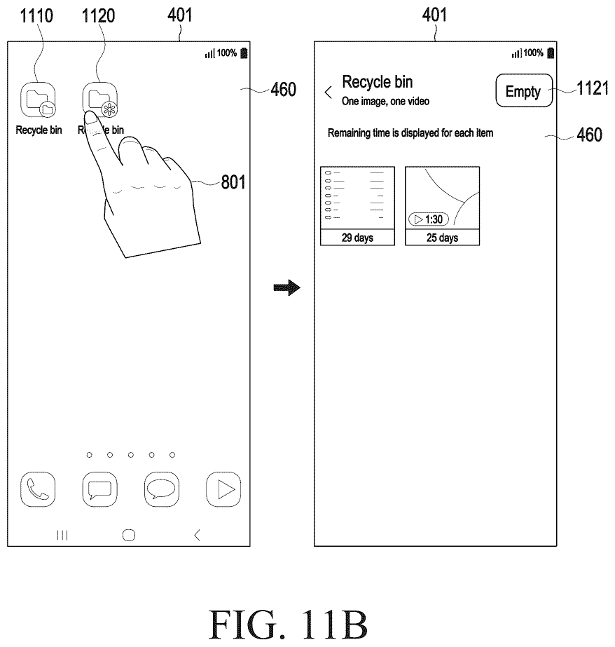

FIGS. 11A and 11B are views illustrating an execution screen of an application displayed when a shortcut icon is selected according to various embodiments of the disclosure.

Referring to FIG. 11A, according to an embodiment, the electronic device 401 may add the shortcut icons 1110 and 1120 to the home screen according to a user input of adding the shortcut icon to the home screen. According to an embodiment, if a user input 801 for selecting the shortcut icon 1110 is identified, the electronic device 401 may display, on the display 460, the execution screen of the management application 310 capable of batch-deleting deletion target data stored in the first area (e.g., 231 of FIG. 2) and the second area (e.g., 232 of FIG. 2). According to an embodiment, the execution screen of the management application (e.g., 310 of FIG. 3) may display the date and time when the deletion target data is deleted, the capacity information about the deletion target data, or information indicating which area of the first area 231 or the second area 232 the deletion target data is stored. According to an embodiment, the execution screen of the management application 310 may display an object 1111 for requesting to batch-delete the deletion target data of a plurality of applications.

According to an embodiment, when the electronic device 401 deletes all of the deletion target data stored in the first area 231 and the second area 232, the electronic device 401 may deactivate the shortcut icon 1110. For example, if a user input for selecting the shortcut icon 1110 is identified in state in which the shortcut icon 1110 is displayed without shading, the electronic device 401 may not display, on the display 460, the execution screen of the management application 310 capable of batch-deleting deletion target data stored in the first area (e.g., 231 of FIG. 2) and the second area (e.g., 232 of FIG. 2). For example, the electronic device 401 may ignore the user input to the deactivated icon. Alternatively, the electronic device 401 may transparently display the deactivated icon.

Referring to FIG. 11B, according to an embodiment, upon identifying a user input for selecting a shortcut icon 1120 for requesting deletion of the deletion target data of the first application 320 or the second application 330 (e.g., Gallery application), the electronic device 401 may display the execution screen of the management application 310 for requesting the deletion target data of the first application or the second application (e.g., Gallery application). According to an embodiment, the execution screen of the management application 310 may display an object 1121 requesting deletion of the deletion target data of the first application or the second application (e.g., a Gallery application).

For example, when the deletion target data of the Gallery application is stored in the first area 231, the management application 310 may transmit a command for deleting the deletion target data to the Gallery application, based on a user input to the object 1121. The Gallery application may access the first area 231 and delete deletion target data stored in the first area 231.

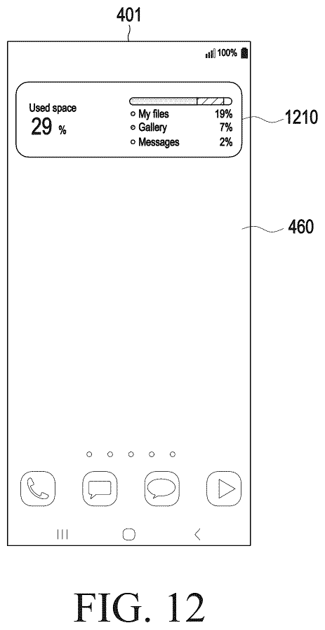

For example, when the deletion target data of the Gallery application is stored in the second area 232, the management application 310 may transmit a command for deleting the deletion target data to the Gallery application, based on a user input to the object 1121. When the Gallery application is authorized to access the second area 232, the Gallery application may access the second area 232 to delete the deletion target data. When the Gallery application is not authorized to access the second area 232, the electronic device 401 may display information for requesting authority for the Gallery application to access the second area 232. FIG. 12 is a view illustrating a widget displayed on a home screen of an electronic device according to an embodiment of the disclosure.

According to an embodiment, the electronic device 401 may display a widget 1210 including information related to the deletion target data of the plurality of applications including the first application 320 and the second application 330 on the home screen.

According to an embodiment, the widget 1210 may include available capacity information about the memory 230, information related to first deletion target data of the first application 320, or information related to second deletion target data of the second application 330.

According to an embodiment, if the first deletion target data is deleted, the electronic device 401 may no longer display information related to the first deletion target data displayed on the widget 1210.

According to an embodiment, if the first deletion target data or the second deletion target data is added, the electronic device 401 may add information related to the first deletion target data or the second deletion target data displayed on the widget 1210.

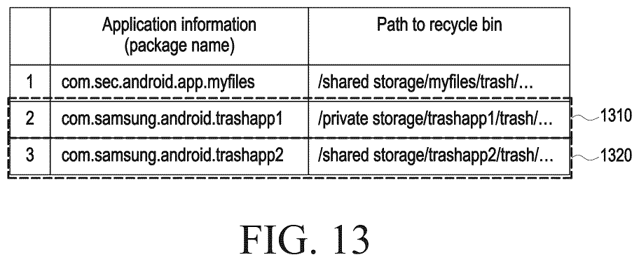

FIG. 13 is a view illustrating information about an application and a recycle bin path of the corresponding application according to an embodiment of the disclosure.

According to an embodiment, the electronic device (e.g., 201 of FIG. 2 or 401 of FIG. 4) may match and store, in the memory (e.g., 230 of FIG. 2), the information about the application and the path information about the area in which the deletion target data of the corresponding application is stored.

According to an embodiment, when the first application 320 storing deletion target data in the first area (e.g., 231 of FIG. 2) is uninstalled, the deletion target data stored in the first area 231 may also be deleted according to the uninstall of the first application 320. According to an embodiment, the electronic device 401 may update and display the deletion of the deletion target data stored in the first area 231 on the execution screen of the management application 310. In this case, the electronic device 401 may update the deletion of the deletion target data of the first application 320 without separately using the path information 1310 about the first application 320.

According to an embodiment, when the second application 330 storing the deletion target data in the second area 232 is uninstalled, the electronic device 401 may identify the recycle bin path information 1320 about the second application 330 stored in the memory 230 to delete the deletion target data stored in the second area 232. According to an embodiment, the electronic device 401 may identify the recycle bin path information 1320 about the second application 330 stored in the memory 230 and delete the deletion target data stored in the second area 232 based on the recycle bin path information 1320. According to an embodiment, the electronic device 401 may update and display the deletion of the deletion target data stored in the second area 232 on the execution screen of the management application 310.

An electronic device according to an embodiment may comprise memory, a display, and at least one processor.

The memory according to an embodiment may store at least one instruction that, when executed by the at least one processor, causes the electronic device to display, on the display, an execution screen of an application including state information about deletion target data of a plurality of applications installed on the electronic device.

The execution screen may include a first object requesting to delete the deletion target data.

The memory according to an embodiment may store at least one instruction that, when executed by the at least one processor, causes the electronic device to transmit a command to each of the plurality of applications to delete the deletion target data of the plurality of applications based on a user input to the first object.

The memory according to an embodiment may store at least one instruction that, when executed by the at least one processor, causes the electronic device to, when first deletion target data of a first application among the plurality of applications is stored in a first area accessible by the first application, display information about a deletion result of the first deletion target data.

The memory according to an embodiment may store at least one instruction that, when executed by the at least one processor, causes the electronic device to, when second deletion target data of a second application among the plurality of applications is stored in a second area requiring an access authority, display information requesting a deletion authority of the second deletion target data.

The execution screen may include a first object requesting to delete the deletion target data.

The memory according to an embodiment may store at least one instruction that, when executed by the at least one processor, causes the electronic device to, when the second application does not have the access authority to the second area, display a popup window as to whether to grant the access authority on the display.

The memory according to an embodiment may store at least one instruction that, when executed by the at least one processor, causes the electronic device to transmit a command for deleting the second deletion target data to the second application based on a user input to grant the access authority.

The memory according to an embodiment may store at least one instruction that, when executed by the at least one processor, causes the electronic device to, when the second application fails to obtain an authority for accessing the second area, display, on the display, information indicating the failure to delete the second deletion target data.

The memory according to an embodiment may store at least one instruction that, when executed by the at least one processor, causes the electronic device to, if the first deletion target data is deleted, transmit a command indicating that the first deletion target data is deleted to the application and update and display state information about the first deletion target data displayed on an execution screen of the application.

The execution screen may include a second object requesting to generate a shortcut icon for the first object.

The memory according to an embodiment may store at least one instruction that, when executed by the at least one processor, causes the electronic device to display, on the display, a shortcut icon for the first object based on a user input to the second object.

The memory according to an embodiment may store at least one instruction that, when executed by the at least one processor, causes the electronic device to display the shortcut icon for the first object on the display to be visually distinct depending on whether to delete the first deletion target data and the second deletion target data.

The memory according to an embodiment may store at least one instruction that, when executed by the at least one processor, causes the electronic device to, if the first deletion target data and the second deletion target data are deleted, deactivate the shortcut icon for the first object based on the user input for selecting the shortcut icon for the first object.

The execution screen may include a third object for adding a shortcut icon related to the first application and a fourth object for adding a shortcut icon related to the second application.

The memory according to an embodiment may store at least one instruction that, when executed by the at least one processor, causes the electronic device to transmit a command to the first application and/or the second application to delete the first deletion target data and/or the second deletion target data based on a user input to the shortcut icon related to the first application and/or the second application.

The memory according to an embodiment may store at least one instruction that, when executed by the at least one processor, causes the electronic device to display, on the display, a shortcut icon for the second object based on a fourth user input to the second object.

The memory according to an embodiment may store at least one instruction that, when executed by the at least one processor, causes the electronic device to display a widget on the display based on a user input for adding the widget.

The widget according to an embodiment may include at least one of capacity information about the memory, information related to the first deletion target data, or information related to the second deletion target data.

The memory according to an embodiment may store at least one instruction that, when executed by the at least one processor, causes the electronic device to, if the first deletion target data is deleted, refrain from displaying the information related to the first deletion target data on the widget.

The method for operating the electronic device according to an embodiment may comprise transmitting a command to each of the plurality of applications to delete the deletion target data of the plurality of applications based on a first user input to the first object.

The method for operating the electronic device according to an embodiment may comprise, when first deletion target data of a first application among the plurality of applications is stored in a first area accessible by the first application, displaying information about a deletion result of the first deletion target data.

The method for operating the electronic device according to an embodiment may comprise, when second deletion target data of a second application among the plurality of applications is stored in a second area requiring an access authority, displaying information requesting a deletion authority of the second deletion target data.

The method for operating the electronic device according to an embodiment may further comprise, when the second application does not have the access authority to the second area, displaying a popup window as to whether to grant the access authority on the display.

The method for operating the electronic device according to an embodiment may further comprise, when the second application fails to obtain an authority for accessing the second area, displaying, on the display, information indicating the failure to delete the second deletion target data.

The method for operating the electronic device according to an embodiment may further comprise, if the first deletion target data is deleted, transmitting a command indicating that the first deletion target data is deleted to the application.

The method for operating the electronic device according to an embodiment may further comprise updating and displaying the state information about the first deletion target data displayed on the execution screen of the application.

The method for operating the electronic device according to an embodiment may further comprise displaying the shortcut icon for the first object on the display based on a second user input to the first object.

The method for operating the electronic device according to an embodiment may further comprise, if the first deletion target data and the second deletion target data are deleted, deactivating the shortcut icon for the first object based on the user input for selecting the shortcut icon for the first object.

The execution screen may include a third object for adding a shortcut icon related to the first application and a fourth object for adding a shortcut icon related to the second application.

The method for operating the electronic device according to an embodiment may further comprise transmitting a command to the first application and/or the second application to delete the first deletion target data and/or the second deletion target data based on a user input to the shortcut icon related to the first application and/or the second application.

The method for operating the electronic device according to an embodiment may further comprise displaying a widget on the display based on a user input for adding the widget.

The widget according to an embodiment may include at least one of capacity information about memory included in the electronic device, information related to the first deletion target data, or information related to the second deletion target data.

A non-transitory recording medium according to an embodiment may store instructions capable of executing displaying, on a display included in an electronic device, an execution screen of an application including state information about deletion target data of a plurality of applications installed on the electronic device.

The execution screen may include a first object requesting to delete the deletion target data.

The non-transitory recording medium according to an embodiment may store instructions capable of executing transmitting a command to each of the plurality of applications to delete the deletion target data of the plurality of applications based on a first user input to the first object.

The non-transitory recording medium according to an embodiment may store instructions capable of executing, when first deletion target data of a first application among the plurality of applications is stored in a first area accessible by the first application, displaying information about a deletion result of the first deletion target data.

The non-transitory recording medium according to an embodiment may store instructions capable of executing, when second deletion target data of a second application among the plurality of applications is stored in a second area requiring an access authority, displaying information requesting a deletion authority of the second deletion target data.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101, 201, or 401). For example, a processor (e.g., the processor 120 or 220) of the machine (e.g., the electronic device 101, 201, or 401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory storing one or more computer programs;
a display; and
one or more processors communicatively coupled to the display and the memory,
wherein the one or more computer programs include computer-executable instructions that, when executed by the one or more processors individually or collectively, cause the electronic device to:
display, on the display, an execution screen of an application including state information about deletion target data of a plurality of applications installed on the electronic device, the execution screen including a first object requesting to delete the deletion target data,
transmit a command to each of the plurality of applications to delete the deletion target data of the plurality of applications based on a user input to the first object,
when first deletion target data of a first application among the plurality of applications is stored in a first area accessible by the first application, display information about a deletion result of the first deletion target data, and
when second deletion target data of a second application among the plurality of applications is stored in a second area requiring an access authority, display information requesting a deletion authority of the second deletion target data.

2. The electronic device of claim 1, wherein the one or more computer programs further comprise include computer-executable instructions that, when executed by the one or more processors individually or collectively, cause the electronic device to, when the second deletion target data of the second application among the plurality of applications is stored in the second area requiring the access authority and when the second application does not have the access authority to the second area, display a popup window as to whether to grant the access authority on the display.

3. The electronic device of claim 1, wherein the one or more computer programs further include computer-executable instructions that, when executed by the one or more processors individually or collectively, cause the electronic device to transmit a command for deleting the second deletion target data to the second application based on a user input to grant the access authority.

4. The electronic device of claim 1, wherein the one or more computer programs further include computer-executable instructions that, when executed by the one or more processors individually or collectively, cause the electronic device to, when the second application fails to obtain an authority for accessing the second area, display, on the display, information indicating a failure to delete the second deletion target data.

5. The electronic device of claim 1, wherein the one or more computer programs further include computer-executable instructions that, when executed by the one or more processors individually or collectively, cause the electronic device to:
if the first deletion target data is deleted, transmit a command indicating that the first deletion target data is deleted to the application; and
update and display state information about the first deletion target data displayed on an execution screen of the application.

6. The electronic device of claim 1,
wherein the execution screen includes a second object requesting to generate a shortcut icon for the first object, and
wherein the one or more computer programs further include computer-executable instructions that, when executed by the one or more processors individually or collectively, cause the electronic device to display, on the display, a shortcut icon for the first object based on a user input to the second object.

7. The electronic device of claim 6, wherein the one or more computer programs further include computer-executable instructions that, when executed by the one or more processors individually or collectively, cause the electronic device to display the shortcut icon for the first object on the display to be visually distinct depending on degrees of deletion of the first deletion target data and the second deletion target data.

8. The electronic device of claim 7, wherein the one or more computer programs further include computer-executable instructions that, when executed by the one or more processors individually or collectively, cause the electronic device to, if the first deletion target data and the second deletion target data are deleted, deactivate the shortcut icon for the first object.

9. The electronic device of claim 1,
wherein the execution screen further includes a third object for adding a shortcut icon related to the first application and a fourth object for adding a shortcut icon related to the second application, and
wherein the one or more computer programs further include computer-executable instructions that, when executed by the one or more processors individually or collectively, cause the electronic device to transmit a command to the first application and/or the second application to delete the first deletion target data and/or the second deletion target data based on a user input to the shortcut icon related to the first application and/or the second application.

10. The electronic device of claim 1,
wherein the one or more computer programs further include computer-executable instructions that, when executed by the one or more processors individually or collectively, cause the electronic device to display a widget on the display based on a user input for adding the widget, and
wherein the widget includes at least one of capacity information about the memory, information related to the first deletion target data, or information related to the second deletion target data.

11. The electronic device of claim 10, wherein the one or more computer programs further include computer-executable instructions that, when executed by the one or more processors individually or collectively, cause the electronic device, if the first deletion target data is deleted, refrain from displaying the information related to the first deletion target data on the widget.

12. A method for operating an electronic device, the method comprising:
displaying, on a display included in the electronic device, an execution screen of an application including state information about deletion target data of a plurality of applications installed on the electronic device, the execution screen including a first object requesting to delete the deletion target data;
transmitting a command to each of the plurality of applications to delete the deletion target data of the plurality of applications based on a first user input to the first object;
when first deletion target data of a first application among the plurality of applications is stored in a first area accessible by the first application, displaying information about a deletion result of the first deletion target data; and
when second deletion target data of a second application among the plurality of applications is stored in a second area requiring an access authority, displaying information requesting a deletion authority of the second deletion target data.

13. The method of claim 12, further comprising, as at least part of when the second deletion target data of the second application among the plurality of applications is stored in the second area requiring the access authority, displaying the information requesting the deletion authority of the second deletion target data, when the second application does not have the access authority to the second area, displaying a popup window as to whether to grant the access authority on the display.

14. The method of claim 12, further comprising, when the second application fails to obtain an authority for accessing the second area, displaying, on the display, information indicating a failure to delete the second deletion target data.

15. The method of claim 12, further comprising:
transmitting a command for deleting the second deletion target data to the second application based on a user input to grant the access authority.

16. The method of claim 12, further comprising:
if the first deletion target data is deleted, transmitting a command indicating that the first deletion target data is deleted to the application; and
updating and displaying state information about the first deletion target data displayed on an execution screen of the application.

17. The method of claim 12,
wherein the execution screen includes a second object requesting to generate a shortcut icon for the first object, and
wherein the method further comprises displaying, on the display, a shortcut icon for the first object based on a user input to the second object.

18. The method of claim 12,
wherein the execution screen further includes a third object for adding a shortcut icon related to the first application and a fourth object for adding a shortcut icon related to the second application, and
wherein the method further comprises transmitting a command to the first application and/or the second application to delete the first deletion target data and/or the second deletion target data based on a user input to the shortcut icon related to the first application and/or the second application.

19. One or more non-transitory computer-readable storage media storing one or more computer programs including computer-executable instructions that, when executed by one or more processors of an electronic device individually or collectively, cause the electronic device to perform operations, the operations comprising:
displaying, on a display included in an electronic device, an execution screen of an application including state information about deletion target data of a plurality of applications installed on the electronic device, the execution screen including a first object requesting to delete the deletion target data;
transmitting a command to each of the plurality of applications to delete the deletion target data of the plurality of applications based on a first user input to the first object;
when first deletion target data of a first application among the plurality of applications is stored in a first area accessible by the first application, displaying information about a deletion result of the first deletion target data; and
when second deletion target data of a second application among the plurality of applications is stored in a second area requiring an access authority, displaying information requesting a deletion authority of the second deletion target data.

20. The one or more non-transitory computer-readable storage media of claim 19, the operations further comprising when the second application fails to obtain an authority for accessing the second area, displaying, on the display, information indicating a failure to delete the second deletion target data.
